(19) United States
(12) Patent Application Publication
(10) Pub. No.: US 2025/0233965 A1
(43) Pub. Date: Jul. 17, 2025

(54) PROJECTION APPARATUS AND PROJECTION METHOD

(71) Applicant: Coretronic Projection (Kunshan) Corporation, Jiangsu (CN)

(72) Inventors: QING LU, Jiangsu (CN); YIFEI SUN, Jiangsu (CN)

(73) Assignee: Coretronic Projection (Kunshan) Corporation, Jiangsu (CN)

(21) Appl. No.: 19/008,535

(22) Filed: Jan. 2, 2025

(30) Foreign Application Priority Data
Jan. 17, 2024 (CN) 202410069546.6

(51) Int. Cl. H04N 9/31

(52) U.S. Cl. CPC H04N 9/3135; H04N 9/3164; H04N 9/3182

(57) ABSTRACT

A projection apparatus and a projection method are provided. The projection apparatus includes a projection module, a driver circuit, and a controller. The projection module is configured to emit an image beam to form a projection picture according to a display data. The display data includes a first color data corresponding to a first color. The driver circuit is coupled to a light source of the projection module. The light source includes a first light source corresponding to the first color. The driver circuit is configured to provide a first driving signal to control a luminance of the first light source. The controller is coupled to the driver circuit. The controller is configured to receive the display data and adjust the first driving signal according to the first color data.

### CROSS-REFERENCE TO RELATED APPLICATION

This application claims the priority benefit of China application serial no. 202410069546.6, filed on Jan. 17, 2024. The entirety of the above-mentioned patent application is hereby incorporated by reference herein and made a part of this specification.

### BACKGROUND

### Technical Field

The disclosure relates to an apparatus and a method, and in particular to a projection apparatus and a projection method.

### Description of Related Art

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

With the advancement of technology, most of existing laser projectors often have hidden risks of eye damage due to the high power output.

### SUMMARY

The disclosure provides a projection apparatus and a projection method, the objectives and advantages of which may be further understood from the technical features disclosed in the disclosure

In order to achieve one, part or all of the above objectives or other objectives, a projection apparatus according to an embodiment of the disclosure includes a projection module, a driver circuit, and a controller. The projection module is configured to emit an image beam to form a projection picture according to a display data. The display data includes a first color data corresponding to a first color. The driver circuit is coupled to a light source of the projection module. The light source is configured to emit an illumination beam required to generate the image beam and include a first light source corresponding to the first color. The driver circuit is configured to provide a first driver signal to control a luminance of the first light source. The controller is coupled to the driver circuit. The controller is configured to receive the display data and adjust the first driver signal according to the first color data.

In order to achieve one, part or all of the above objectives or other objectives, a projection method according to an embodiment of the disclosure is configured to control a projection apparatus. The projection method includes following steps. An illumination beam is emitted from a light source by a projection module of the projection apparatus to form a projection picture according to a display data, where the display data includes a first color data corresponding to a first color. A first driver signal is provided by a driver circuit of the projection apparatus to control a luminance of a first light source emitted by the first color of the light source. The display data is received by a controller of the projection apparatus, where the first driver signal is adjusted according to the first color data.

Other objectives, features, and advantages of the present invention will be further understood from the further technological features disclosed by the embodiments of the present invention where there are shown and described preferred embodiments of this invention, simply by way of illustration of modes best suited to carry out the invention.

### BRIEF DESCRIPTION OF THE DRAWINGS

FIG. 1 is a block diagram of a projection apparatus according to an embodiment of the disclosure.

FIG. 2 is a schematic diagram of operation of a projection apparatus adjusting a first color according to an embodiment of the disclosure.

FIG. 3 is a schematic diagram of a user interface according to an embodiment of the disclosure.

FIG. 4 is a flow chart of a projection method according to an embodiment of the disclosure.

FIG. 5 is a flow chart of another projection method according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having,” and variations thereof herein is meant to encompass the items listed thereafter and equivalents thereof as well as additional items. Unless limited otherwise, the terms “connected, “coupled,” and “mounted,” and variations thereof are used broadly and encompass direct and indirect connections, couplings, and mountings.

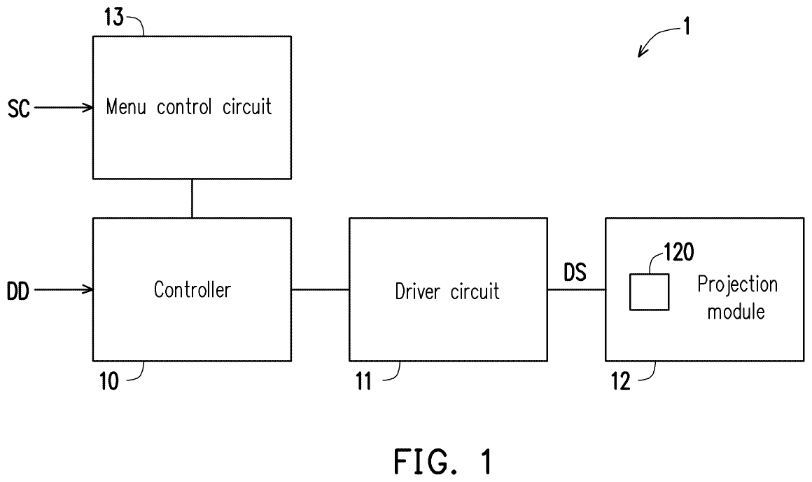

FIG. 1 is a block diagram of a projection apparatus according to an embodiment of the disclosure. A projection apparatus 1 includes a controller 10, a driver circuit 11, a projection module 12, and a menu control circuit 13. The projection module 12 may be configured to emit an image beam to form a projection picture according to a display data DD, where the display data DD includes multiple color data of each basic color luminance of the projection picture. The driver circuit 11 is coupled to a light source 120 of the projection module 12. The light source 120 may be configured to emit an illumination beam required to generate the image beam. The driver circuit 11 may provide a driver signal DS to the projection module 12 to adjust the luminance of the image beam emitted by the projection module 12. For example, the driver circuit 11 provides the driver signal DS to the light source 120 of the projection module 12 to change the luminance of the illumination beam, thereby adjusting the luminance of the image beam. Further, the controller 10 is coupled to the driver circuit 11. The controller 10 may be configured to receive the display data DD and may instruct the driver circuit 11 to adjust the driver signal DS sent by the driver circuit 11, so that the light source 120 emits the illumination beam corresponding to the luminance indicated by the display data DD.

Specifically, the light source 120 may emit color beams with different colors to jointly form the illumination beam and may form the projection picture by superimposing the image beams converted by the illumination beams with various colors. Further, the display data DD received by the controller 10 includes the color data corresponding to the color beams emitted by the light source 120 respectively. The controller 10 may adjust a first driver signal corresponding to a first color of the driver signal DS according to the first color data of the display data DD, thereby adjusting the luminance of a first light source corresponding to the first color of the light source 120. In particular, the first color may be blue, red, or green. If the first color is blue, the risk of blue light harming human eyes and the power consumption of the projection apparatus are reduced. If the first color is red or green, the power consumption of the projection apparatus is reduced.

In some embodiments, the light source 120 may have, for example, the first light source to a third light source. The light source 120 may emit the first to the third color beams with blue, red, and green respectively to form the illumination beam. The driver signal provided by the driver circuit 11 may include the first driver signal to a third driver signal. The first to the third driver signals may be configured to control the luminance of the first to the third light sources of the light source 120 respectively. Further, each piece of the display data DD received by the controller 10 may be, for example, the display data DD configured to display a frame projection picture. The display data DD includes the first to the third color data corresponding to blue, red, and green respectively. The controller 10 may adjust the first driver signal provided to the first light source according to a maximum color data value of the first color data of the display data DD. In particular, the controller 10 may adjust the first driver signal of each frame according to the display data of each frame or may adjust the first driver signal of the projection picture every several frames (for example, ten frames of the projection picture).

In some embodiments, the light source 120 of the projection module 12 may be, for example, the first to the third light sources having the beams emitting different colors or only a single light source. Specifically, when the light source 120 has the first to the third light sources and may respectively emit the first to the third color beams with different colors, the first to the third light sources may be driven by the first to the third driver signals of the driver signal respectively to emit the first to the third color beams corresponding the luminance in each color beam interval. Alternatively, when the light source 120 has only a single light source (for example, the blue light source), the beam emitted by the single light source may be directed to phosphor sheets with different colors on a phosphor wheel to generate the first to the third color beams with different colors in different time intervals, and the driver circuit 11 may control the luminance of the single light source in a corresponding time interval according to the first to the third driver signals.

Specifically, when the projection apparatus 1 performs projection, the color beams (the illumination beams) with different colors emitted by the light source 120 may be, for example, emitted to a digital micromirror device (DMD). The DMD has multiple reflector structures. The reflector structures are respectively controlled by a control signal, so that the reflected first to the third color beams may respectively have indicated patterns corresponding to the first to the third color data, thereby forming the projection picture. In this case, the controller 10 may set the luminance of the first light source according to the maximum color data value of the first color data of the display data DD. In other words, the controller 10 may obtain the highest grayscale value (that is, the maximum color data value) of the first color of each frame picture according to the first color data of the display data DD to set the luminance corresponding to the first light source of the light source accordingly. In this way, the luminance of the first light source may be adjusted according to the maximum color data value of the first color data of each frame picture, thereby adjusting the power consumption of the projection apparatus 1.

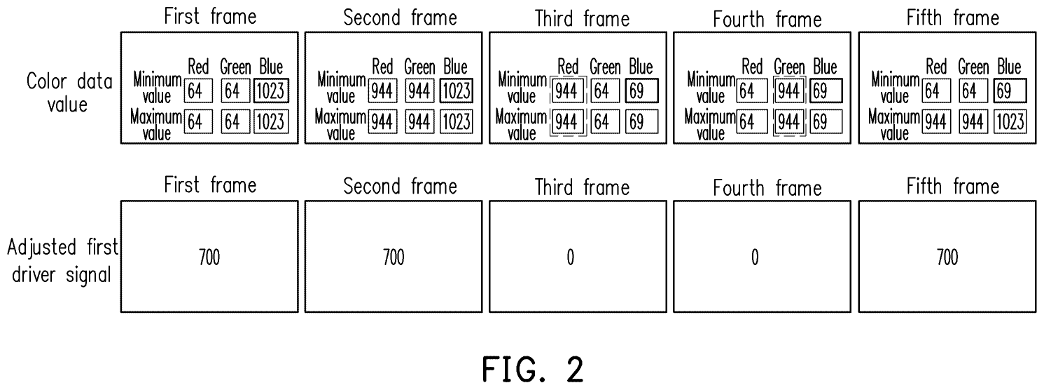

In some embodiments, the projection apparatus 1 may adjust the luminance of at least one of red, blue, and green colors of the projection picture generated by the projection apparatus 1. For example, the projection apparatus 1 may reduce the blue luminance of the projection picture, thereby achieving a purpose of reducing the risk of eye damage to the user and protecting the vision of the user by reducing the blue light signal of the light source. More specifically, FIG. 2 is a schematic diagram of operation of a projection apparatus adjusting a first color according to an embodiment of the disclosure. FIG. 2 shows the color data values of the first to the third colors and the adjusted driver signal DS (for example, the first driver signal) of the first to the fifth frames. In this embodiment, the blue color is regarded as the adjusted first color to describe the operation performed by the projection apparatus 1.

Specifically, the controller 10 may have the various color data values (for example, the grayscale value) of all pixels of a frame picture according to the received display data DD. The controller 10 may obtain the color data values of the first to the third colors of each frame picture shown in the upper half of FIG. 2 according to the display data DD. The driver signal DS provided by the driver circuit 11 to the projection module 12 may be, for example, a pulse width modulation signal. Further, the controller 10 may adjust the driver signal DS according to the maximum color data value of the first color (for example, the blue color) of each frame picture, so that the luminance of the first color of the projection picture generated by the projection apparatus 1 may be reduced. For example, referring to Table 1 below, the first driver signal (the setting value of the pulse width modulation signal, that is, the value of the pulse width modulation) of the driver signal DS is set according to a data interval in which the maximum color data value of the first color falls and controls the blue light source to emit the first color beam.

TABLE I

| Data interval in which | Default setting value | Adjusted setting value |
|---|---|---|
| the maximum color | of pulse width | of pulse width |
| data value falls | modulation signal | modulation signal |
| 1023~751 | 1000 | 700 |
| 750~501 | 1000 | 350 |
| 500~0 | 1000 | 0 |

In Table 1, a value range of the color data value (the color data value of the first color may, for example, fall in the range of the maximum value of the default color data and the minimum value of the default color data, such as a range of 0 to 1023; the maximum value of the default color data and the minimum value of the default color data are, for example, stored in the controller 10) is divided into a high-intensity interval (for example, a range of 1023 to 751), a medium-intensity interval (for example, a range of 750 to 501), and a low-intensity interval (for example, a range of 500 to 0). Each intensity interval respectively has an upper limit value and a lower limit value, as well as the adjusted setting value of the pulse width modulation signal corresponding to each intensity interval. The controller 10 may define the intensity interval in which the maximum color data value of the first color is located as a current intensity interval and may adjust the first driver signal according to the current intensity interval. As shown in the lower half of FIG. 2, for example, the first frame picture is a picture with sky. In the display data DD of the first frame picture, the maximum color data value of the first color data (for example, the blue data) of each pixel of the picture is, for example, 1023. The third frame picture is, for example, a picture with indoor at night. In the display data DD of the third frame picture, the maximum color data value of the first color data (for example, the blue data) of each pixel of the picture is, for example, 69. Therefore, the first driver signal is adjusted to be 700, 700, 0, 0, and 700 of the pulse width setting values corresponding to the color data values of the first to the fifth frames respectively. Compared with the method of setting the setting value of the first driver signal as 1000 (the default setting value of the pulse width modulation signal of the first driver signal) by the common technology all the time, the projection apparatus 1 may effectively and moderately reduce blue light and the power consumption of the projection apparatus 1. In another aspect, in this embodiment, the projection apparatus 1 does not adjust the second driver signal and the third driver signal corresponding to the green light and the red light, so the user cannot easily detect the adjustment changes of the blue light source. It should be noted that the values in Table 1 are only examples for description. The number of data intervals may be designed according to different scenarios, and the number of data intervals drawn in Table 1 may also be greater than one (for example, three), which may be adjusted according to the choice of the user.

In some embodiments, the controller 10 may set the default setting value of the first color driver signal DS of the light source by multiplying a default magnification (a multiplied value is taken by an integer value) or subtracting a default value (the lowest value is 0) to adjust the first driver signal (the system of the pulse width modulation signal of the first driver signal may set a value, for example, as a range between 0 and 1023) according to the interval (that is, the current intensity interval) in which the first color data value of the display data DD falls. The default magnification falls in a range, for example, between 0.6 and 0.8. The subtracted default value falls in a range, for example, between 200 and 500. In particular, the default magnification or the subtracted default value may be different or the same according to the interval in which the first color data value of the display data DD falls. Therefore, the driver circuit 11 may adjust the luminance of the first to the third light sources of the light source 120 according to the adjusted driver signal DS to emit the first to the third color beams. In some embodiments, the driver signal DS provided by the driver circuit 11 to the projection module 12 may be, for example, an analog voltage or a current signal. The driver circuit 11 may set the voltage levels or the current levels of the first to the third driver signals by the adjusted driver signal DS, thereby adjusting the luminance of the first to the third light sources of the light source 120.

In some embodiments, the controller 10 may be, for example, a central processing unit (CPU), a programmable micro control unit (MCU) for a common purpose or a specific purpose, a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), any other kinds of processor of an integrated circuit, a state machine, an advanced reduced instruction set computer machine (ARM), other similar components, or a combination thereof. The driver circuit 11 may be, for example, a digital-to-analog converter or a pulse width modulation circuit. The driver circuit 11 is configured to generate the corresponding driver signal according to the instruction of the controller 10 and sets the luminance of the first to the third light sources of the light source 120 by a pulse width, a voltage, or a current value of the driver signal. For example, the menu control circuit 13 may be, for example, a hardware circuit used to execute an on-screen display menu and may be coupled to an input device controlled by the user, such as a mouse, a keyboard, a touch panel, or other similar input devices to receive a selection command SC generated by the user through the operating of the on-screen display menu.

In this way, through the reduction in the luminance of the first light source that emits the first color beam of the light source 120 of the projection apparatus 1, the power consumption of the projection apparatus 1 may be effectively reduced by 8% to 13%. Moreover, when the first color that reduces the luminance is blue, the first color may still effectively protect the vision of the user and reduce the risk of eye damage to the user. In another aspect, since the process of reducing the luminance only uses the maximum color data value of the first color, the signal processing process of the controller 10 is relatively simple and fast, thereby achieving the real time adjustment of the projection picture.

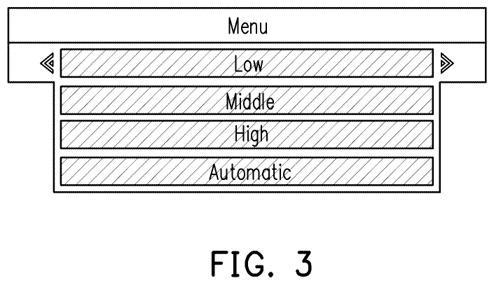

FIG. 3 is a schematic diagram of a user interface according to an embodiment of the disclosure Specifically, the projection apparatus 1 may further include the menu control circuit 13. The menu control circuit 13 may be, for example, an input circuit which may be provided to the user for operation. The menu control circuit 13 may be, for example, an on-screen display (OSD) menu and may be configured to provide an operation menu to the user. Furthermore, the menu control circuit 13 may receive the corresponding selection command SC generated by the selection of the user according to the coupled input device. As shown in FIG. 3, different adjustment modes of the luminance may be displayed on the operation menu, such as high, middle, low, and automatic. The user may make selections according to the options on the operation menu. The menu control circuit 13 may be configured to receive the operation on the operation menu by the user and may generate the selection command SC, and the controller 10 may set the adjusted amplitude of the first driver signal according to the selection command SC, so that the first light source has the corresponding luminance. In this way, the controller 10 may set the default magnification to be multiplied or the default value to be subtracted by the pulse width modulation signal of the first color driver signal of the light source according to the adjustment mode selected by the user.

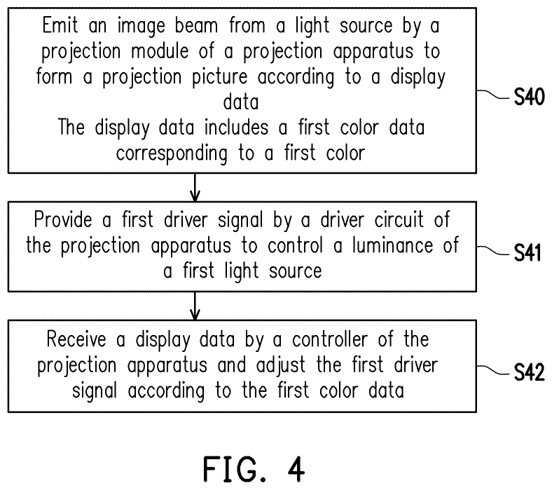

FIG. 4 is a flow chart of a projection method according to an embodiment of the disclosure. The projection method in FIG. 4 may be executed by the projection apparatus 1 in FIG. 1. The projection method in FIG. 4 includes steps S40 to S42.

In step S40, the projection module 1 of the projection apparatus 1 may emit the image beam from the light source 120 to form the projection picture according to the display data DD. The display data DD at least includes the first color data corresponding to the first color. In step S41, the driver circuit 11 of the projection apparatus 1 may provide the first driver signal to control the luminance of the first light source that emits the first color of the light source 120. In step S42, the controller 10 of the projection apparatus 1 receives the display data DD and adjusts the first driver signal according to the first color data of the display data. Detail of the projection method may be referred to the relevant paragraphs on the operation of the projection apparatus 1 described above and is not repeated here.

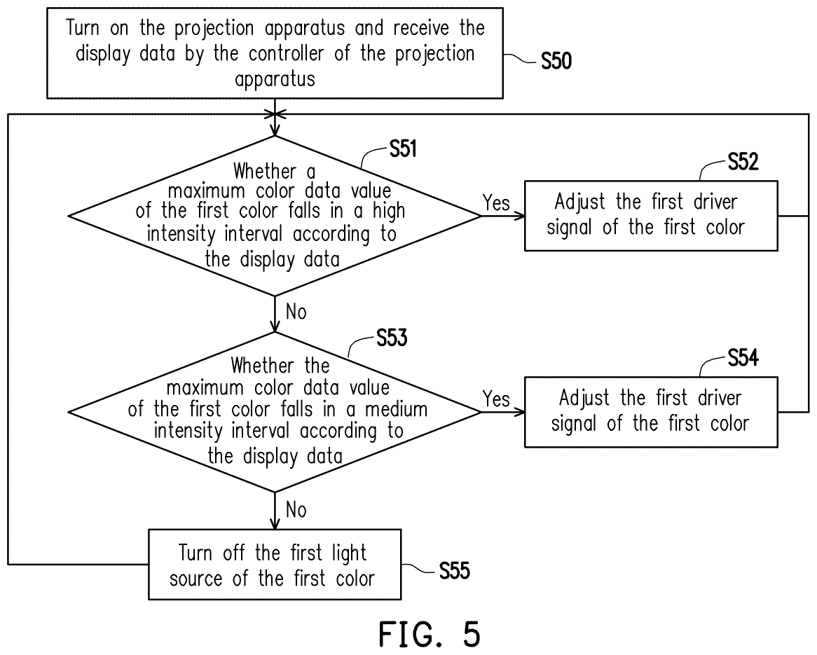

FIG. 5 is a flow chart of another projection method according to an embodiment of the disclosure. The projection method in FIG. 5 may also be executed by the projection apparatus 1 in FIG. 1. The projection method in FIG. 5 includes steps S50 to S55.

In step S50, when the projection apparatus 1 is first turned on, the controller 10 of the projection apparatus 1 may receive the display data DD relative to the frame projection picture. The display data DD includes the values (for example, the grayscale value) of the first to the third color data of all pixels of the frame picture.

In step S51, the controller 10 may determine whether the maximum color data value of the first color falls in the high intensity interval according to the display data DD. For example, the controller 10 may determine the maximum color data value of each color in a received frame picture according to the display data DD. Further, the controller 10 may compare the maximum color data value of the first color, for example, with the lower limit value of the high intensity interval in Table 1 to determine whether the maximum color data value of the first color falls in the high intensity interval. When the judgment result of the controller 10 is yes, step S52 is entered. On the contrary, when the judgment result of the controller 10 is no, step S53 is entered.

In step S52, the controller 10 may adjust the first driver signal of the first color. In some embodiments, the controller 10 may set the first driver signal (the setting value of the pulse width modulation signal) of the driver signal DS according to the data interval in which the maximum color data value of the first color falls, as described in the aforementioned paragraph related to Table 1, and control the blue light source by the first driver signal to emit the first color beam. For example, when the controller 10 determines that the maximum color data value falls in the data interval of 751 to 1023, the controller 10 may set the setting value of the corresponding first driver signal as 700.

In some embodiments, the controller 10 may set the default setting value of the first color driver signal of the light source by multiplying the default magnification corresponding to the high intensity interval or subtracting the default value corresponding to the high intensity interval to set the setting value corresponding to the first driver signal, thereby adjusting the luminance of the first light source.

In step S53, the controller 10 may determine whether the maximum color data value of the first color falls in the medium intensity interval according to the display data DD. Similar to step S51, the controller 10 may compare the maximum color data value of the first color, for example, with the lower limit value of the medium intensity interval in Table 1 to determine whether the maximum color data value of the first color falls in the medium intensity interval. When the judgment result of the controller 10 is yes, step S54 is entered. On the contrary, when the judgment result of the controller 10 is no, step S55 is entered.

In step S54, the controller 10 may adjust the first driver signal of the first color. In some embodiments, the controller 10 may set the first driver signal (the setting value of the pulse width modulation signal) of the driver signal DS according to the data interval in which the maximum color data value of the first color falls, as described in the aforementioned paragraph related to Table 1, and control the blue light source by the first driver signal to emit the first color beam. For example, when the controller 10 determines that the maximum color data value falls in the data interval of 501 to 750, the controller 10 may set the setting value of the corresponding first driver signal as 350.

In some embodiments, the controller 10 may multiply the default setting value of the first color driver signal DS of the light source by the default magnification corresponding to the medium intensity interval or may subtract the default value corresponding to the medium intensity interval to set the setting value of the corresponding first driver signal, thereby adjusting the luminance of the first light source.

In step S55, when the controller 10 determines that the maximum color data value of the first color falls in the low intensity interval, the controller 10 may control to turn off (for example, the pulse width modulation signal is set as 0) the first light source that emits the first color beam. In some embodiments, the controller 10 may set the first driver signal (the setting value of the pulse width modulation signal) of the driver signal DS according to the data interval in which the maximum color data value of the first color falls, as described in the aforementioned paragraph related to Table 1, and control the blue light source by the first driver signal whether to emit the first color beam. For example, when the controller 10 determines that the maximum color data value falls in the data interval of 0 to 500 (the judgment result of step S53 is no), the controller 10 may set the setting value of the corresponding first driver signal as 0.

In summary, the projection apparatus and the projection method of the disclosure have at least one of the following advantages: reducing the luminance of the first color of the projection picture effectively, improving the user experience under the circumstance protecting the vision of the user, or reducing the power consumption of the projection apparatus. In addition, since the overall adjustment process only requires the controller to determine the maximum color data value of the first color of the display data, the signal processing process is relatively simple, so that the real time adjustment during the projection process may be achieved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby enabling persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a projection module, configured to emit an image beam to form a projection picture according to a display data, wherein the display data includes a first color data corresponding to a first color;
a driver circuit, coupled to a light source of the projection module, wherein the light source is configured to emit an illumination beam required to generate the image beam and include a first light source corresponding to the first color, and the driver circuit is configured to provide a first driver signal to control a luminance of the first light source; and
a controller, coupled to the driver circuit, wherein the controller is configured to receive the display data and adjust the first driver signal according to the first color data.

2. The projection apparatus according to claim 1, wherein the first driver signal is adjusted according to a maximum color data value of the first color data of a frame projection picture.

3. The projection apparatus according to claim 1, wherein the illumination beam emitted by the light source of the projection module includes a first color beam emitted in a first color beam interval and a second color beam emitted in a second color beam interval, and the driver circuit is configured to control a luminance of the light source in the first color beam interval and a luminance of the light source in the second color beam interval.

4. The projection apparatus according to claim 1, wherein the first color is blue, red, or green.

5. The projection apparatus according to claim 2, wherein the controller stores a maximum value of a default color data and a minimum value of the default color data and divides a plurality of intensity intervals between the maximum value of the default color data and the minimum value of the default color data, and the controller is configured to define a current intensity interval according to an intensity interval among the plurality of intensity intervals in which the maximum color data value is located and adjusts the first driver signal according to the current intensity interval.

6. The projection apparatus according to claim 5, wherein the first driver signal is a pulse width modulation value, and the controller is configured to set a default setting value of the first driver signal by multiplying a default magnification or subtracting a default value to set the pulse width modulation value of the first driver signal according to the current intensity interval.

7. The projection apparatus according claim 1, wherein the light source of the projection module further comprises a second light source corresponding to a second color and a third light source corresponding to a third color, and the driver circuit is further configured to provide a second driver signal and a third driver signal to control a luminance of the second light source and a luminance of the third light source respectively.

8. The projection apparatus according to claim 1, further comprising a menu control circuit, wherein the menu control circuit is configured to provide an on-screen display menu to a user for an operation and generate a corresponding selection command, so that the controller sets an adjusted amplitude of the first driver signal according to the selection command.

9. A projection method for controlling a projection apparatus, the projection method comprising:
emitting an illumination beam from a light source by a projection module of the projection apparatus to form a projection picture according to a display data, wherein the display data comprises a first color data corresponding to a first color;
providing a first driver signal by a driver circuit of the projection apparatus to control a luminance of a first light source emitted by the first color of the light source; and
receiving the display data by a controller of the projection apparatus, wherein the first driver signal is adjusted according to the first color data.

10. The projection method according to claim 9, comprising adjusting the first driver signal according to a maximum color data value of the first color data of a frame projection picture.

11. The projection method according to claim 9, comprising:
emitting the illumination beam comprising a first color beam in a first color beam interval and a second color beam in a second color beam interval by the light source of the projection module; and
controlling a luminance of the light source in the first color beam interval and a luminance of the light source in the second color beam interval by the driver circuit.

12. The projection method according to claim 9, wherein the first color is blue, red, or green.

13. The projection method according to claim 10, comprising:
storing a maximum value of a default color data and a minimum value of the default color data by the controller, wherein a plurality of intensity intervals are divided between the maximum value of the default color data and the minimum value of the default color data; and
defining a current intensity interval by the controller according to an intensity interval of the plurality of intensity intervals in which the maximum value of the default color data is located, wherein the first driver signal is adjusted according to the current intensity interval.

14. The projection method according to claim 13, wherein the first driver signal is a pulse width modulation value, and the projection method comprises:
setting a default setting value of the first driver signal by multiplying a default magnification or subtracting a default value by the controller to set the pulse width modulation value of the first driver signal according to the current intensity interval.

15. The projection method according to claim 9, wherein the light source of the projection module further comprises a second light source corresponding to a second color and a third light source corresponding to a third color, and the projection method comprises:
providing a second driver signal and a third driver signal by the driver circuit to control a luminance of the second light source and a luminance of the third light source respectively.

16. The projection method according to claim 9, further comprising:
receiving a selection command inputted by a user through operating an on-screen display menu by a menu control circuit of the projection apparatus, wherein the selection command is provided to the controller, so that the controller sets an adjusted amplitude of the first driver signal according to the selection command.
